(19) United States
(12) Patent Application Publication
(10) Pub. No.: US 2012/0080536 A1
(43) Pub. Date: Apr. 5, 2012

(54) METHOD FOR CONTROLLING A FUEL INJECTOR

(75) Inventors: Scott E. Parrish, Farmington Hills, MI (US); Paul M. Najt, Bloomfield Hills, MI (US)

(73) Assignee: GM GLOBAL TECHNOLOGY OPERATIONS LLC, Detroit, MI (US)

(21) Appl. No.: 13/234,342

(22) Filed: Sep. 16, 2011

Related U.S. Application Data
(60) Provisional application No. 61/389,850, filed on Oct. 5, 2010.

(51) Int. Cl. F02D 41/30

(52) U.S. Cl. 239/5

(57) ABSTRACT

A method for controlling an electromagnetically-activated fuel injector includes determining an injector activation signal having an injection duration, an initial peak pull-in current and a secondary hold current corresponding to a preferred injected fuel mass for a fuel injection event associated with a non-monotonic region of injector operation, and controlling the fuel injector using the injector activation signal to achieve the preferred injected fuel mass for the fuel injection event.

### CROSS REFERENCE TO RELATED APPLICATIONS

This application claims the benefit of U.S. Provisional Application No. 61/389,850, filed on Oct. 5, 2010, which is incorporated herein by reference.

### TECHNICAL FIELD

This disclosure relates to solenoid-activated fuel injectors employed on internal combustion engines.

### BACKGROUND

The statements in this section merely provide background information related to the present disclosure and may not constitute prior art.

Fuel injectors are used to directly inject pressurized fuel into combustion chambers of internal combustion engines. Known fuel injectors include electromagnetically-activated solenoid devices that overcome mechanical springs to open a valve located at a tip of the injector to permit fuel flow therethrough. Injector driver circuits control flow of electric current to the electromagnetically-activated solenoid devices to open and close the injectors. Injector driver circuits may operate in a peak-and-hold control configuration or a saturated switch configuration.

Fuel injectors are calibrated, with a calibration including an injector activation signal including an injector open-time, or injection duration, and a corresponding metered or delivered fuel mass operating at a predetermined or known fuel pressure. Injector operation may be characterized in terms of fuel mass per fuel injection event in relation to injection duration. Injector characterization includes metered fuel flow over a range between high flowrate associated with high-speed, high-load engine operation and low flowrate associated with engine idle conditions. An injector characterization may include a region of linear operation and a region of non-linear operation.

A region of linear operation is a region whereat the fuel injector delivers a predictable injected fuel mass in response to an injection duration at a known fuel pressure. A region of non-linear operation is a region whereat a change in the injection duration may not result in a corresponding and predictable change in the injected fuel mass at a known fuel pressure. Known solenoid-actuated injectors exhibit nonlinear flow characteristics when metering small quantities of fuel at low injection durations. Known engine operating systems avoid operating fuel injectors in non-linear regions of operation due to the unpredictable nature of the injected fuel mass.

### SUMMARY

A method for controlling an electromagnetically-activated fuel injector includes determining an injector activation signal having an injection duration, an initial peak pull-in current and a secondary hold current corresponding to a preferred injected fuel mass for a fuel injection event associated with a non-monotonic region of injector operation, and controlling the fuel injector using the injector activation signal to achieve the preferred injected fuel mass for the fuel injection event.

### BRIEF DESCRIPTION OF THE DRAWINGS

One or more embodiments will now be described, by way of example, with reference to the accompanying drawings, in which:

FIG. 1 is a schematic sectional view of a fuel injector and control system, in accordance with the disclosure;

FIG. 2 is a datagraph depicting injected fuel mass in relation to injection duration for an exemplary fuel injector, in accordance with the disclosure;

FIGS. 3-1, 3-2, 3-3, and 3-4 are datagraphs depicting injector activation signals shown as current profiles, with each injector activation signal having an injection duration of 0.5 ms, an initial peak pull-in current and a secondary hold current for initial peak pull-in currents of 7 A, 9 A, 11 A, and 13 A, respectively, in accordance with the disclosure; and

FIGS. 4 and 5 are datagraphs depicting commanded injected fuel mass in relation to injection duration for an exemplary direct injection fuel injector operating at different initial peak pull-in currents and different secondary hold currents including embodiments of an injector calibration in accordance with the disclosure.

### DETAILED DESCRIPTION

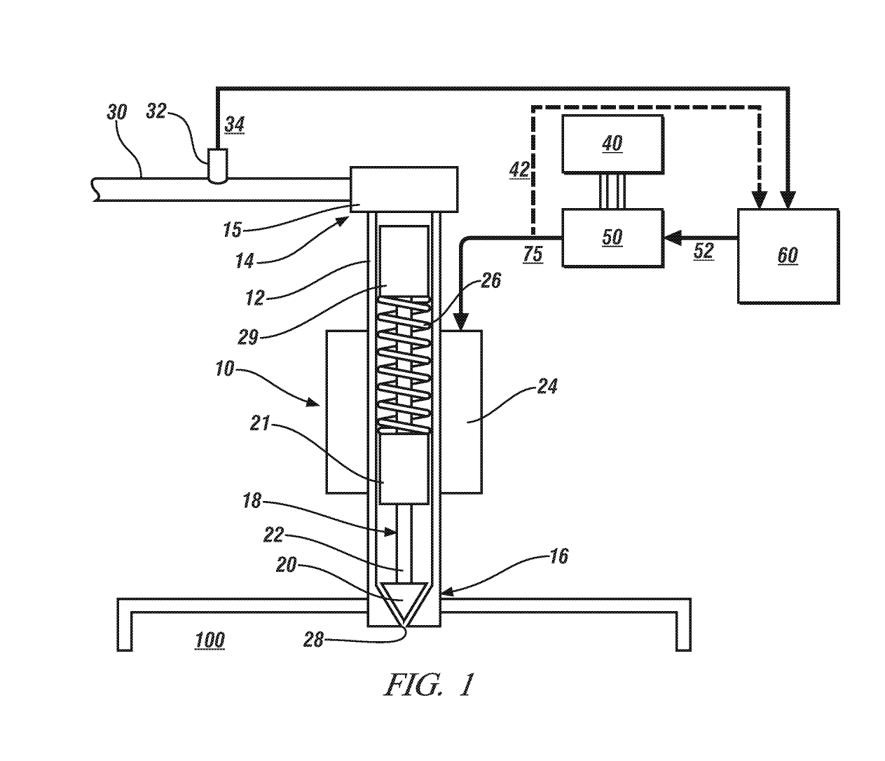

Referring now to the drawings, wherein the showings are for the purpose of illustrating certain exemplary embodiments only and not for the purpose of limiting the same, FIG. 1 schematically illustrates an embodiment of an electromagnetically-activated fuel injector 10. The electromagnetically-activated direct-injection fuel injector 10 is configured to inject fuel directly into a combustion chamber 100 of an internal combustion engine. A control module 60 electrically operatively connects to an injector driver 50 that electrically operatively connects to the fuel injector 10 to control activation thereof. The fuel injector 10, control module 60 and injector driver 50 may be any suitable devices that are configured to operate as described herein.

The fuel injector 10 may be any suitable discrete fuel injection device that is controllable to one of an open position (as shown) and a closed position. In one embodiment, the fuel injector 10 includes a cylindrically-shaped hollow body 12 defining a longitudinal axis. A fuel inlet 15 is located at a first end 14 of the body 12 and a fuel nozzle 28 is located at a second end 16 of the body 12. The fuel inlet 15 fluidly couples to a high-pressure fuel line 30 that fluidly couples to a high-pressure fuel injection pump. In one embodiment, the high-pressure fuel injection pump provides pressurized fuel at a line pressure of 20 MPa. A valve assembly 18 is contained in the body 12, and includes a needle valve 20 and a spring-activated plunger 22. The needle valve 20 interferingly fits in the fuel nozzle 28 to control fuel flow therethrough. An annular electromagnetic coil 24 is configured to magnetically engage a guide portion 21 of the valve assembly 18. When the electromagnetic coil 24 is deactivated, a spring 26 urges the valve assembly 18 including the needle valve 20 towards the fuel nozzle 28 to close the needle valve 20 and prevent fuel flow therethrough. When the electromagnetic coil 24 is activated, electromagnetic force acts on the guide portion 21 to overcome the spring force exerted by the spring 26 and urges the valve assembly 18 open, moving the needle valve 20 away from the fuel nozzle 28 and permitting flow of pressurized fuel within the valve assembly 18 to flow through the fuel nozzle 28. The fuel injector 10 may include a stopper 29 that interacts with the valve assembly 18 to stop translation of the valve assembly 18 when it is urged open. It is appreciated that other electromagnetically-activated fuel injectors may be employed without limitation. In one embodiment, a pressure sensor 32 is configured to monitor fuel pressure 34 in the high-pressure fuel line 30 proximal to the fuel injector 10, preferably upstream of the fuel injector 10. In an engine configuration employing a common-rail fuel injection system, a single pressure sensor 32 may be employed to monitor fuel pressure 34 in the high-pressure fuel line 30 for a plurality of fuel injectors 10. It is appreciated that other configurations for fuel pressure monitoring proximal to the fuel injector 10 may be employed. The control module 60 monitors signal outputs from the pressure sensor 32 to determine the fuel pressure 34 proximal to the fuel injector 10 and monitors an injector voltage 42, i.e., electric potential across the electromagnetic coil 24 of the fuel injector 10.

Control module, module, control, controller, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality. Software, firmware, programs, instructions, routines, code, algorithms and similar terms mean any controller executable instruction sets including calibrations and look-up tables. The control module has a set of control routines executed to provide the desired functions. Routines are executed, such as by a central processing unit, and are operable to monitor inputs from sensing devices and other networked control modules, and execute control and diagnostic routines to control operation of actuators. Routines may be executed at regular intervals, for example each 3.125, 6.25, 12.5, 25 and 100 milliseconds during ongoing engine and vehicle operation. Alternatively, routines may be executed in response to occurrence of an event.

The control module 60 generates an injector command signal 52 that controls the injector driver 50, which activates the fuel injector 10 to effect a fuel injection event. The injector command signal 52 correlates to a mass of fuel delivered by the fuel injector 10 during the fuel injection event. The injector driver 50 generates an injector activation signal 75 in response to the injector command signal 52 to activate the fuel injector 10. The injector activation signal 75 controls current flow to the electromagnetic coil 24 to generate electromagnetic force in response to the injector command signal 52. An electric power source 40 provides a source of DC electric power for the injector driver 50. When activated using the injector activation signal 75, the electromagnetic coil 24 generates electromagnetic force to urge the valve assembly 18 open, allowing pressurized fuel to flow therethrough. The injector driver 50 controls the injector activation signal 75 to the electromagnetic coil 24 by any suitable method, including, e.g., pulsewidth-modulate electric power flow. The injector driver 50 is configured to control activation of the fuel injector 10 by generating suitable injector activation signals 75, e.g., injector activation signals described with reference to FIGS. 3-1 to 3-4.

The injector activation signal 75 is characterized by an initial peak pull-in current, a secondary hold current, and an injection duration. The initial peak pull-in current is characterized by a steady-state ramp up to achieve a peak current, which may be selected as described herein. The initial peak pull-in current generates electromagnetic force in the electromagnetic coil 24 that acts on the guide portion 21 of the valve assembly 18 to overcome the spring force and urge the valve assembly 18 open, initiating flow of pressurized fuel through the fuel nozzle 28. When the initial peak pull-in current is achieved, the injector driver 50 reduces the current in the electromagnetic coil 24 to the secondary hold current. The secondary hold current is characterized by a somewhat steady-state current that is less than the initial peak pull-in current. The secondary hold current is a current level controlled by the injector driver 50 to maintain the valve assembly 18 in the open position to continue the flow of pressurized fuel through the fuel nozzle 28. The secondary hold current is preferably indicated by a minimum current level.

Injection duration corresponds to a time that begins with initiation of the initial peak pull-in current and ends when the secondary hold current is released, thus deactivating the electromagnetic coil 24. When the electromagnetic coil 24 is deactivated, the electric current and corresponding electromagnetic force dissipate and the spring 26 urges the valve assembly 18 toward the nozzle 28, thus closing the fuel injector 10 and discontinuing fuel flow therethrough. The injection duration may be defined as a pulsewidth, preferably measured in milliseconds (ms).

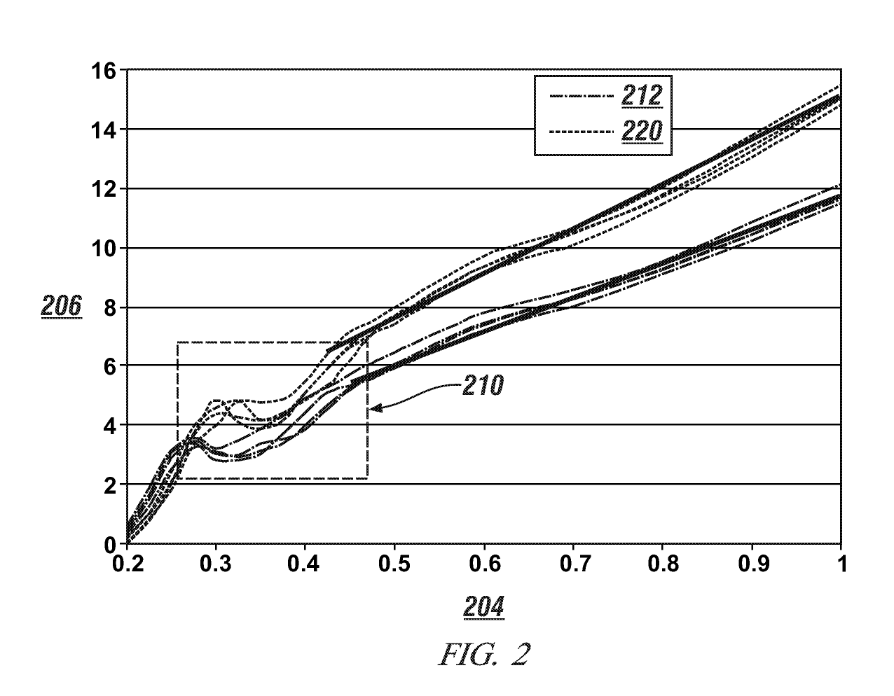

FIG. 2 graphically shows injected fuel mass (mg) 206 on the vertical axis in relation to injection duration (ms) 204 on the horizontal axis. Plotted data includes flow curves associated with operating an exemplary electromagnetically-activated direct-injection fuel injector 10, including injection flow curves 212 and 220 depicting injection flow masses corresponding to operation at inlet fuel pressures of 12 MPa and 20 MPa, respectively. As is appreciated, a monotonic relationship is a relationship wherein a dependent variable moves in only one direction with an increase in an independent variable. The depicted data includes a non-monotonic region of operation 210, i.e., a region of injection duration whereat a change in the injection duration may not result in a corresponding and predictable change in injected fuel mass. Thus, a particular injected fuel mass may be achieved at more than one injection duration in the non-monotonic region of operation 210. The non-monotonic region of operation 210 occurs at injection durations between about 0.25 ms and about 0.45 ms in one embodiment, with corresponding injected fuel mass ranging from less than about 3 mg to greater than about 6 mg. The injection duration times and corresponding injected fuel masses are illustrative.

FIGS. 3-1 through 3-4 graphically show electrical current (A) 302 on the vertical axis in relation to injection duration (ms) 304 on the horizontal axis. The plotted data includes injector activation signals depicted as current profiles, with each injector activation signal having an injection duration of 0.5 ms, an initial peak pull-in current and a secondary hold current as described herein.

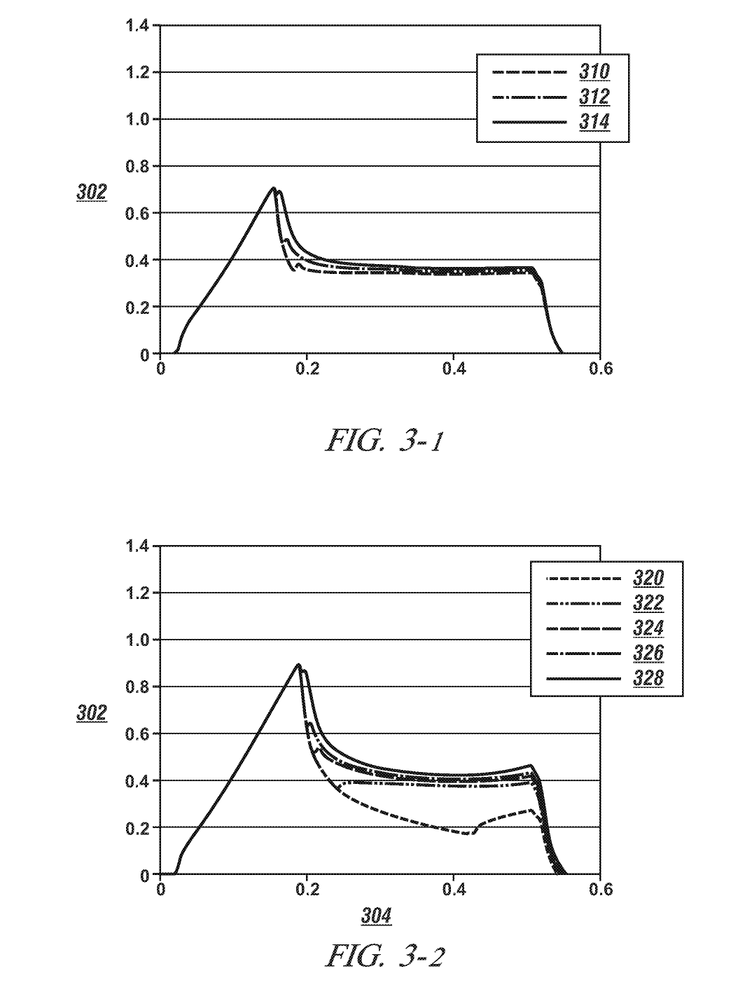

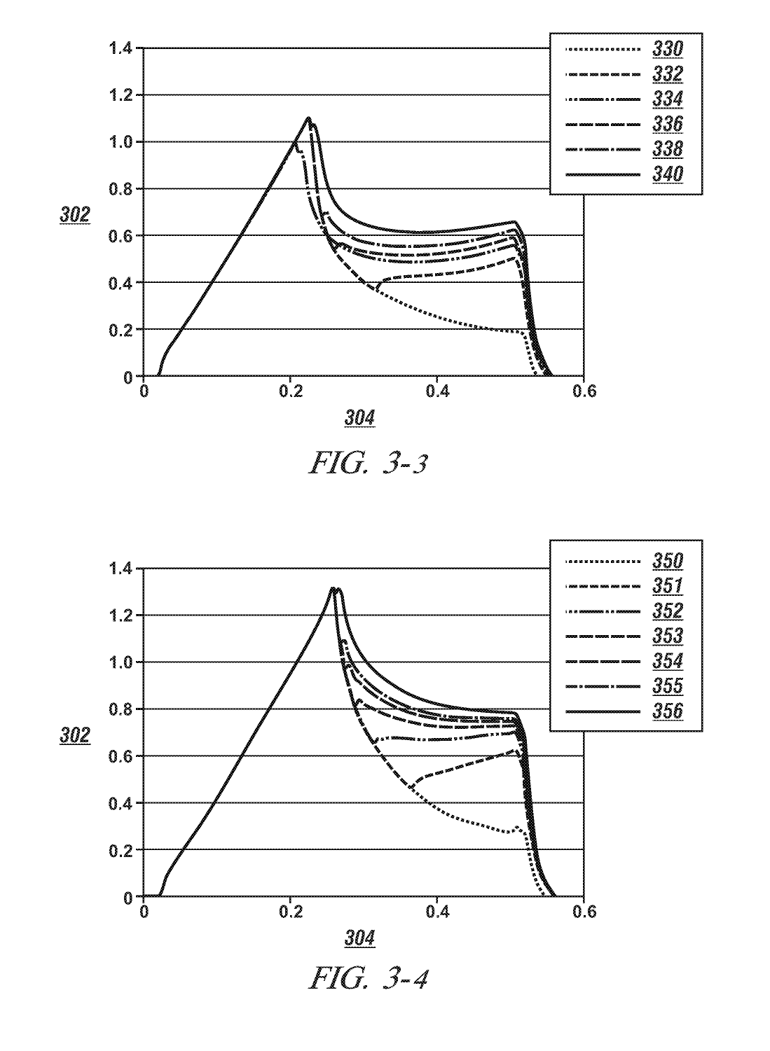

FIG. 3-1 graphically shows current profiles for injector activation signals having initial peak pull-in currents of 7 A at an injection duration of 0.5 ms, including injector activation signal 310 with a secondary hold current of 4 A, injector activation signal 312 with a secondary hold current of 6 A, and injector activation signal 314 with a secondary hold current of 8 A.

FIG. 3-2 graphically shows current profiles for injector activation signals having initial peak pull-in currents of 9 A at an injection duration of 0.5 ms, including injector activation signal 320 with a secondary hold current of 2 A, injector activation signal 322 with a secondary hold current of 4 A, injector activation signal 324 with a secondary hold current of 6 A, injector activation signal 326 with a secondary hold current of 8 A, and injector activation signal 328 with a secondary hold current of 10 A.

FIG. 3-3 graphically shows current profiles for injector activation signals having initial peak pull-in currents of 11 A at an injection duration of 0.5 ms, including injector activation signal 330 with a secondary hold current of 2 A, injector activation signal 332 with a secondary hold current of 4 A, injector activation signal 334 with a secondary hold current of 6 A, injector activation signal 336 with a secondary hold current of 8 A, injector activation signal 338 with a secondary hold current of 10 A, and injector activation signal 340 with a secondary hold current of 12 A.

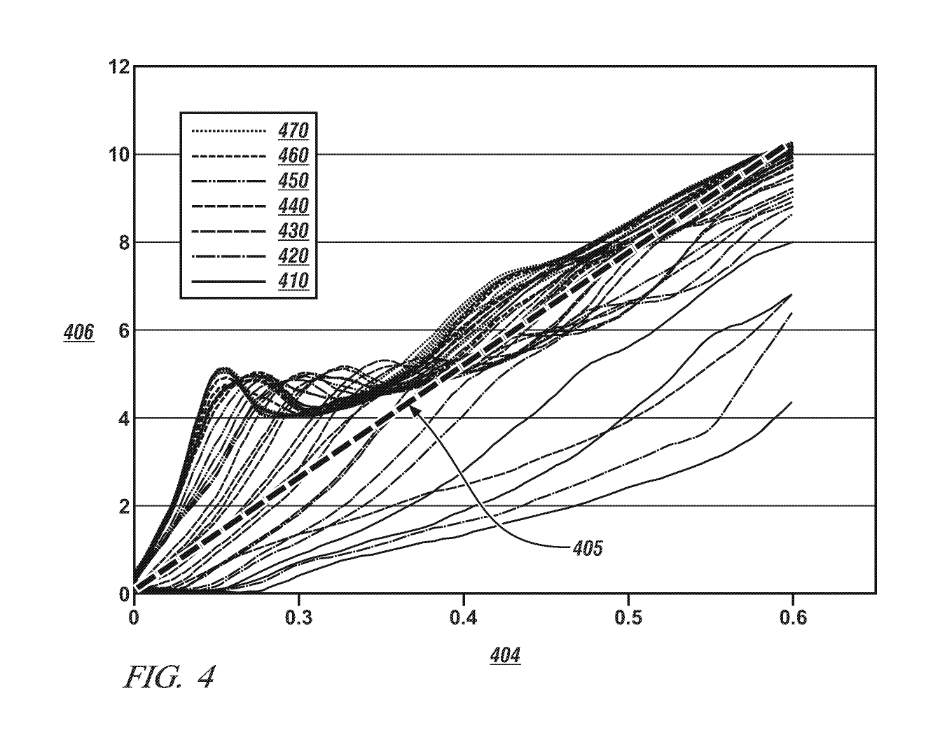

FIG. 3-4 graphically shows current profiles for injector activation signals having initial peak pull-in currents of 13 A at an injection duration of 0.5 ms, including injector activation signal 350 with a secondary hold current of 3 A, injector activation signal 351 with a secondary hold current of 5 A, injector activation signal 352 with a secondary hold current of 7 A, injector activation signal 353 with a secondary hold current of 9 A, injector activation signal 354 with a secondary hold current of 11 A, injector activation signal 355 with a secondary hold current of 13 A, and injector activation signal 356 with a secondary hold current of 14 A.

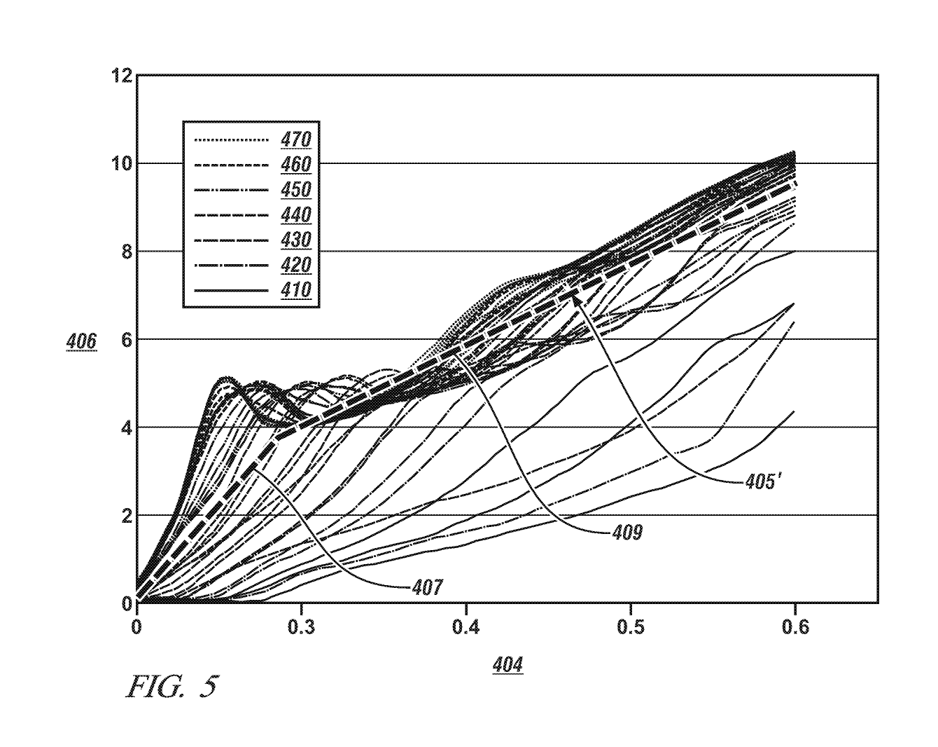

FIGS. 4 and 5 are each datagraphs depicting commanded injected fuel mass (mg) 406 in relation to injection duration (ms) 404 for an exemplary embodiment of the electromagnetically-activated direct-injection fuel injector 10 in a non-monotonic region of operation 210. The fuel injector 10 exhibits substantially nonlinear flow characteristics when metering small quantities, e.g., between 2 mg and 6 mg of fuel. The electromagnetically-activated direct-injection fuel injector 10 is controlled employing injector activation signals analogous to those shown with reference to FIGS. 3-1 through 3-4, with the injector activation signals controlled at injection durations between 0.2 ms and 0.6 ms, with fuel pressure of 20 MPa.

The fuel flow curves depicted in FIG. 4 indicate that a fuel injector may be repeatably controlled to achieve a commanded injected fuel mass within a previously-identified non-monotonic region of operation. The plurality of flow curves for the injector activation signals include the following:
Lines 410, each having an initial peak pull-in current of 7 A and a secondary hold current of one of 4 A, 6 A, and 8 A, over a range of injection durations between 0.2 to 0.6 ms;
Lines 420, each having an initial peak pull-in current of 8 A and a secondary hold current of 3 A, 5 A, 7 A, and 9 A, over a range of injection durations between 0.2 to 0.6 ms;
Lines 430, each having an initial peak pull-in current of 9 A and a secondary hold current of one of 2 A, 4 A, 6 A, 8 A, and 10 A over a range of injection durations between 0.2 to 0.6 ms;
Lines 440, each having an initial peak pull-in current of 10 A and a secondary hold current of one of 2 A, 4 A, 6 A, 8 A, 10 A, and 11 A over a range of injection durations between 0.2 to 0.6 ms;
Lines 450, each having an initial peak pull-in current of 11 A and a secondary hold current of one of 2 A, 4 A, 6 A, 8 A, 10 A, and 12 A over a range of injection durations between 0.2 to 0.6 ms;
Lines 460, each having an initial peak pull-in current of 12 A and a secondary hold current of 3 A, 4 A, 6 A, 8 A, 10 A, 12 A and 13 A over a range of injection durations between 0.2 to 0.6 ms; and
Lines 470, each having an initial peak pull-in current of 13 A and a secondary hold current of one of 5 A, 7 A, 9 A, and 11 A over a range of injection durations between 0.2 to 0.6 ms.

The fuel injector may be controlled using an injector command, which is the injector activation signal having an injection duration and a combination of an initial peak pull-in current and a secondary hold current level. The fuel injector may be controlled to achieve the commanded injected fuel mass within the non-monotonic region of operation. This permits control of the commanded injected fuel mass in a range between less than about 3 mg to greater than about 6 mg in one embodiment, which is the previously identified non-monotonic region of operation. The control of the commanded injected fuel mass in the non-monotonic region of operation is achieved at a single fuel pressure (20 MPa, as shown) using the selected injector activation signal originating in the control module from a pre-established injector calibration.

Fuel flow curves analogous to those depicted in FIGS. 4 and 5 are developed and employed to develop the pre-established injector calibration that includes commanded injected fuel masses within the non-monotonic region of operation of injection durations for an embodiment of the fuel injector 10. The pre-established injector calibration is preferably an array of discrete states stored in a memory device of the control module 60. The array of discrete states includes a plurality of commanded injected fuel masses and a corresponding plurality of injector activation signals. Each injector activation signal includes an injection duration and a combination of an initial peak pull-in current level and a secondary hold current level. The pre-established injector calibration is employed to determine an injector activation signal to achieve a commanded injected fuel mass in response to an engine operating command within the non-monotonic region of operation. The commanded injected fuel masses and corresponding injector activation signals including discrete states for injection duration, initial peak pull-in current and secondary hold current are retrievable, and may be employed to control activation of the fuel injector in response to an engine operating command that has been converted to a commanded injected fuel mass. The pre-established calibration may instead be in the form of an algorithmic equation or equations. It is appreciated that the control module 60 includes another injector calibration for determining an injector activation signal to achieve a commanded injected fuel mass in response to an engine operating command outside the non-monotonic region of operation of injection durations.

In operation, a commanded injected fuel mass is determined in response to an engine operating command that includes a commanded engine operating point. As is appreciated, engine operating points range between high-load conditions and no-load/idle conditions. The control module 60 interrogates the pre-established injector calibration using the commanded injected fuel mass to determine preferred states for injection duration, initial peak pull-in current and secondary hold current, and employs the preferred states for injection duration, initial peak pull-in current and secondary hold current to operate the fuel injector to achieve a commanded injected fuel mass in response to an engine operating command within the non-monotonic region of operation of injection durations.

FIG. 4 graphically shows one embodiment of an injector calibration 405 suitable for controlling operation of the fuel injector 10. The injector calibration 405 includes a single, linear, monotonic curve that encompasses commanded injected fuel mass states 406 for injected fuel masses corresponding to the non-monotonic region of operation, i.e., the injection duration region between 3 mg and 6 mg in one embodiment. The injected fuel masses between 3 mg and 6 mg correspond to the non-monotonic region of operation 210 shown for the injection flow curve 220 shown with reference to FIG. 2. Corresponding injector activation signals including injection durations and combinations of initial peak pull-in current and secondary hold current level, which may be determined for discrete injected fuel mass points between 3 mg and 6 mg in the embodiment shown.

FIG. 5 graphically shows a second embodiment of injector calibration 405′ that is suitable for controlling operation of the fuel injector 10 in the non-monotonic region of operation. The injector calibration 405′ includes a first, linear, monotonic curve 407 and a second linear, monotonic curve 409. The first, linear, monotonic curve 407 encompasses injection duration states 404 and corresponding injected fuel mass states 406 for injected masses between 2 mg and 3 mg in one embodiment, and has a first slope. The second linear, monotonic curve 409 encompasses injection duration states 404 and corresponding injected fuel mass states 406 for injected masses between 3 mg and 6 mg in one embodiment, and has a second slope. In one embodiment, the first slope is steeper than the second slope, as shown. The depicted data is illustrative. The injector calibration 405′ encompasses injection duration states 404 and corresponding injected fuel mass states 406 for injected masses between 3 mg and 6 mg in one embodiment, which correspond to the non-monotonic region of operation 210 shown for the injection flow curve 220 depicting injection flow masses corresponding to operation at the inlet fuel pressure of 20 MPa. It is appreciated that other embodiments of the injector calibration 405 for the plurality of flow curves shown with reference to FIG. 4 may be developed and employed to control operation of the fuel injector 10 in the non-monotonic region of operation.

Controlling the fuel injector 10 to deliver a commanded injected fuel mass for a fuel injection event associated with the non-monotonic region of injector operation includes determining the injector activation signal, and using the injector activation signal including the injection duration, the initial peak pull-in current and the secondary hold current to control operation of the fuel injector in the non-monotonic region of injector operation. Such operation is employed to achieve improved metering of small quantities of fuel from the fuel injector 10. It is appreciated that the aforementioned operation may be employed to achieve improved metering of a broad range of quantities of fuel from the fuel injector 10 both less than and greater than the non-monotonic region of injector operation.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. Method for controlling an electromagnetically-activated fuel injector, comprising:
determining an injector activation signal comprising an injection duration, an initial peak pull-in current and a secondary hold current corresponding to a preferred injected fuel mass for a fuel injection event associated with a non-monotonic region of injector operation; and
controlling the fuel injector using the injector activation signal to achieve the preferred injected fuel mass for the fuel injection event.

2. The method of claim 1, wherein determining the injector activation signal comprises selecting the injector activation signal from an injector calibration in response to an engine operating point.

3. The method of claim 2, wherein selecting the injector activation signal from the injector calibration in response to an engine operating point comprises selecting the injector activation signal from an array of discrete states including a plurality of commanded injected fuel masses and a corresponding plurality of injector activation signals.

4. The method of claim 3, wherein selecting the injector activation signal from an array of discrete states comprises selecting the injector activation signal from an array of discrete states corresponding to a linear monotonic curve that encompasses injected fuel mass states corresponding to the non-monotonic region of injector operation.

5. The method of claim 3, wherein selecting the injector activation signal from an array of discrete states comprises selecting the injector activation signal from an array of discrete states corresponding to a first linear monotonic curve that encompasses injected fuel mass states corresponding to a first portion of the non-monotonic region of injector operation and a second linear monotonic curve that encompasses injected fuel mass states corresponding to a second portion of the non-monotonic region of injector operation.

6. Method for controlling an electromagnetically-activated fuel injector, comprising:
determining a preferred fuel mass for a fuel injection event;
determining an injector activation signal comprising an injection duration, an initial peak pull-in current and a secondary hold current corresponding to the preferred fuel mass for the fuel injection event; and
controlling the fuel injector using the injector activation signal comprising the injection duration, the initial peak pull-in current and the secondary hold current.

7. The method of claim 6, wherein determining the injector activation signal comprises selecting the injector activation signal from a pre-established injector calibration.

8. The method of claim 7, wherein selecting the injector activation signal from the pre-established injector calibration comprises selecting the injector activation signal from an array of discrete states including a plurality of commanded injected fuel masses and a corresponding plurality of injector activation signals.

9. The method of claim 8, wherein the array of discrete states comprises a single, linear, monotonic curve that encompasses commanded injected fuel masses corresponding to a non-monotonic region of injector operation.

10. The method of claim 8, wherein the array of discrete states comprises a first linear, monotonic curve that encompasses commanded injected fuel masses corresponding to a first portion of a non-monotonic region of injector operation and a second linear, monotonic curve that encompasses commanded injected fuel masses corresponding to a second portion of the non-monotonic region of injector operation.

11. Method for controlling an electromagnetically-activated fuel injector to deliver a preferred injected fuel mass, comprising:
selecting an injector activation signal comprising an injection duration, an initial peak pull-in current and a secondary hold current corresponding to the preferred injected fuel mass when the preferred injected fuel mass is associated with a non-monotonic region of injector operation; and
controlling an injector driver circuit using the injector activation signal comprising the injection duration, the initial peak pull-in current and the secondary hold current to activate the fuel injector.

12. The method of claim 11, wherein selecting the injector activation signal comprises selecting the injector activation signal from an injector calibration in response to an engine operating point associated with the non-monotonic region of injector operation.

13. The method of claim 12, wherein selecting the injector activation signal from the injector calibration in response to the engine operating point associated with the non-monotonic region of injector operation comprises selecting the injector activation signal from an array of discrete states including a plurality of commanded injected fuel masses and a corresponding plurality of injector activation signals.

14. The method of claim 13, wherein selecting the injector activation signal from an array of discrete states including a plurality of commanded injected fuel masses and a corresponding plurality of injector activation signals comprises selecting the injector activation signal from an array of discrete states corresponding to a linear monotonic curve that encompasses injected fuel mass states corresponding to the non-monotonic region of injector operation.

15. The method of claim 13, wherein selecting the injector activation signal from an array of discrete states including a plurality of commanded injected fuel masses and a corresponding plurality of injector activation signals comprises selecting the injector activation signal from an array of discrete states corresponding to a first linear monotonic curve that encompasses injected fuel mass states corresponding to a first portion of the non-monotonic region of injector operation and a second linear monotonic curve that encompasses injected fuel mass states corresponding to a second portion of the non-monotonic region of injector operation.
